(19) United States
(12) Patent Application Publication
(10) Pub. No.: US 2009/0042469 A1
(43) Pub. Date: Feb. 12, 2009

(54) Superhydrophilic and Superhydrophobic Powder Coated Fabric

(75) Inventor: John T. Simpson, Clinton, TN (US)

Correspondence Address: UT-Battelle, LLC;Office of Intellectual Property, One Bethal Valley Road, 4500N, MS-6258, Oak Ridge, TN, 37831, US

(73) Assignee: UT-BATTELLE, LLC, Oak Ridge, TN (US)

(21) Appl. No.: 11/837,076

(22) Filed: Aug. 10, 2007

(51) Int. Cl. B32B 5/02

(52) U.S. Cl. 442/118

(57) ABSTRACT

Superhydrophilic and superhydrophobic fabrics are taught having a superhydrophilic or superhydrophobic powder disposed on the fabric. The superhydrophilic powder has at least one material of sodium borosilicate glass and porous diatomaceous earth. The powder material has a contiguous interpenetrating structure with a plurality of spaced apart nanostructured surface features. The superhydrophilic powder is switched to superhydrophobic by adding at least one superhydrophobic material of perfluorinated organics, fluorinated organics, and self-assembled monolayers.

### CROSS-REFERENCE TO RELATED APPLICATIONS

This application is related to; 1) U.S. patent application Ser. No. 11/749,852, entitled “Super-Hydrophobic Water Repellent Powder”, filed May 17, 2007; 2) U.S. patent application Ser. No. 10/900,249, entitled “Composite, Nano-Structured, Super-Hydrophobic Material”, filed Jul. 27, 2004; 3) U.S. patent application Ser. No. 11/463,964, entitled “Composite, Nano-Structured, Super-Hydrophobic Material”, filed Aug. 11, 2006; and 4) U.S. patent application Ser. No. 11/777,486, entitled “Superhydrophobic Diatomaceous Earth”, filed Jul. 13, 2007; all herein incorporated by reference.

### STATEMENT REGARDING FEDERALLY SPONSORED RESEARCH

This invention was made with United States Government support under Contract No. DE-AC05-00OR22725 between the United States Department of Energy and U.T. Battelle, LLC. The United States Government has certain rights in this invention.

### BACKGROUND OF THE INVENTION

Both superhydrophobic (SHB) and superhydrophilic (SHL) powders can be manufactured by controlling surface texture and chemistry at the nanoscale and microscale. Stable superhydrophobic surfaces with advancing and receding water droplet contact angles in excess of 150° as well as stable superhydrophilic surfaces with contact angles less than 5° are possible. In the case of the superhydrophilic powder, nearly instantaneous water wetting is observed as well as uniform water sheeting across the surface during drying. Applying these powders to fabric transfers the properties of the powder to the fabric.

The phenomenon of superhydrophobicity, inspired from the “lotus leaf effect,” has led to the technological development of superhydrophobic materials and coatings, which consist of a hydrophobic, rough surface with low surface energy. The lotus leaf effect is revealed from a study of the surfaces of lotus leaves. The surface of a lotus leaf is covered with countless miniature protrusions coated with a waxy layer. This waxy layer acts as a multifunctional interface between the leaf and its environment, influencing the airflow and light reflection, and imparting very high water repellency to the leaf to cause water to roll over its surface as small droplets. These hydrophobic microscopic topographical features minimize the area of contact of water with the leaf surface, thereby keeping the water in contact mainly with air. Hence the water on the leaf surface substantially retains the droplet shape it would have in air. One of the methods of measuring the water repellency of a surface is to measure contact angle of a water drop with the surface. Higher contact angles imply enhanced hydrophobic surface and greater water repellency. Smooth hydrophobic surfaces tend to have contact angles up to 110° and 120° for certain Teflon materials, but the rough microstructures present on the lotus leaf result in contact angles as high as 170°, thereby imparting to the surface enhanced superhydrophobic properties.

Since much of the superior water-repellency of the lotus leaf derives from the structural (microscopic features) and chemical (waxy) properties, extensive research has been carried out to develop techniques to create such microscopic features and wax-like properties on artificial surfaces. For example, the development of superhydrophobic materials and surfaces have been investigated for practical and technical applications such as water repelling and self-cleaning coatings for fabrics and textiles; coatings that impart wrinkle resistance to fabric; self-cleaning coatings for ovens, electric ranges, filters, and window blinds; anti-soiling coatings for titanium surfaces, transparent substrates, painted surfaces, wall-papers, and washing-machine tubs; water-repellant and self-cleaning coatings for automobile glass, optics, laser glass, exterior walls of buildings, paints; anti-corrosion coatings; and coatings for biomedical applications. Typically, artificial hydrophobic surfaces must have contact angles greater than 150° to acquire the “super” prefix.

A variety of approaches have been followed in order to create a hydrophobic surface with microrough features to impart superhydrophobic properties to the surface. Hydrophobic materials developed thus far are based on polymeric systems such as poly (phytanyl methacrylate), a copolymer of 2-isopropenyl-2oxazoline and methyl methacrylate, other acrylic-siloxane based systems, silica and aluminum based polymer systems, a hybrid hydrophobic material comprising electro-deposited nickel and organofluoro polymeric components on a glass substrate, and polymers comprising one or more fluoro groups. The microroughness on the surface of coatings comprising the foregoing hydrophobic materials was created by employing techniques such as dispersing particles made of TiO₂ in a hydrophobic polymer for photocatalytic assistance in formation of self-cleaning surfaces, dispersing polymeric and metallic particles, chemical micropatterning, self-assembly, photolithography, capillary force lithography, and soft lithography. Some of these surface coatings can also be applied to fabric using various methods.

A major problem in making water repellant superhydrophobic fabrics has been the lack of an easy and inexpensive way of making these fabrics. Typically, water repellant fabrics have very poor quality (i.e. water is poorly repelled and doesn't really form an air layer between the water and raw fiber as is the case for truly superhydrophobic fibers). The higher quality superhydrophobic materials tend to be very expensive and structurally not amenable to coating fibers and fabrics. By using an inexpensive, highly porous, nanostructured superhydrophobic powder, many of the major problems are overcome.

Superhydrophobic, superrepellant and self-cleaning fibers could bring a large number of benefits to the textile industry including the potential to replace conventional fluorochemical based finishing products used for providing water repellency or low friction to textile surfaces. The super-repellent textile materials can be extremely important when suits protective against chemical and biological weapon are designed. Moreover, such fiber surfaces can be thought of as being liquid superconductors with superhydrophobic fibers transporting fluids essentially on a bed of air. When water is passed over such a surface it will exhibit elements of a self-cleaning process. It is clear that superhydrophobic fibers and superhydrophobic-like substrates will revolutionize and extend the capability of many textile-based applications as well as create new product markets. Enhanced properties of many standard textile assemblies is expected, for example, a combination of hydrophilic fibers with superhydrophobic fibers will produce smart or extreme textile assemblies that will push moisture away from the body very rapidly and pull it through the fabric for quick drying.

Numerous hydrophobic materials have been developed, including PTFE, nylon, glass fibers, polyethersulfone and aggregates having hydrophobic properties. One such material is disclosed in U.S. Pat. No. 3,562,153, to Tully et al. The oil absorbent compositions of the Tully et al. patent are obtained by treating a liquid absorbent material, which may be particulate, granular or fibrous in nature, with a colloidal metal or metalloid oxide which is chemically bonded to an organosilicon compound to render the metal or metalloid oxide hydrophobic. The hydrophobic oxide-treated absorbent composition is contacted with the oil-contaminated water and selectively removes the oil therefrom. The oil absorbent composition of Tully et al. is reported to have excellent water repellency, thus enabling it to maintain its oil absorbent efficiency for long immersion periods.

U.S. Pat. No. 4,474,852, to Craig, combines ideas of several prior art patents (U.S. Pat. Nos. 3,567,492; 3,672,945; 3,973,510; 3,980,566; 4,148,941; and 4,256,501). According to Craig, hydrophobic composites having superior water repellency are obtainable by depositing on a particulate and granular core material an adherent first coat which comprises a film-forming polyurethane and asphalt, as an optional additive, and applying to the thus coated core material a second coat comprising a hydrophobic colloidal oxide such as, for example, hydrophobic fumed silica. Craig teaches that the adherent first coat should not exceed 1 weight percentage of the total dry aggregate weight while the second coat is between 0.025 and 0.25 weight percentage of this total weight. Further according to the teachings of Craig, hydrophobic composites prepared in this manner not only prevent water from adhering to the surfaces of the individual composite particles, but also from entering the interstitial spaces of the aggregates of the composites.

WO 03/044124 also discloses a method of preparing hydrophobic aggregates, which is based on the teachings of Craig (U.S. Pat. No. 4,474,852). According to the teachings of WO 03/044124, the hydrophobic aggregates disclosed in U.S. Pat. No. 4,474,852 are not satisfactory as they do not withstand water pressure higher than 2-3 centimeters.

In a search for a method of producing hydrophobic aggregates with improved water-repellency and oil absorbency performance and improved durability under higher water pressures, it was concluded, according to the teachings of WO 03/044124, that an improved method of preparing hydrophobic aggregates, as compared with the teachings of Craig, should include changes relating to the compositions of the first and second coat and the relative amounts thereof, to the temperature in the various process steps and to the mixing rate during the course of preparation. Hence, the method disclosed in WO 03/044124 includes depositing on a particulate or granulate core material an adherent first coat which comprises a film-forming agent such as polyurethane and optionally a gluing agent such as liquid asphalt, and applying to the thus coated core material a second coat which comprises a hydrophobic fumed silicate or any other superhydrophobic powder. According to the teachings of WO 03/044124, the adherent first coat constitutes about 1-2 weight percentages of the total dry aggregate weight while the second coat constitutes more than 5 weight percentages of this total weight. Further according to the teachings of WO 03/044124, such hydrophobic aggregate is capable of holding a water pressure of up to 20-30 cm.

Although WO 03/044124 teaches the use of superhydrophobic powders other than hydrophobic fumed silica, this reference neither specifies nor exemplifies such a superhydrophobic powder. This reference also fails to demonstrate any performance of the hydrophobic aggregates disclosed therein with regard to both, water repellency and its behavior under high water pressures. Furthermore, it is well known in the art that using such a large amount of hydrophobic fumed silica as the second coat, as taught by WO 03/044124, reduces the cost-effectiveness as well as the simplicity of the process.

In addition, hydrophobic fumed silica, as well as other metal oxides treated with organosilicon compounds, such as those disclosed in the Craig patent, are characterized as acidic substances, aggregates coated by such materials are susceptible to reactions with alkaline reagents such as detergents. This feature limits the use of such aggregates in applications where detergents may be in contact with the hydrophobic aggregates, such as, for example, top-coatings of various surfaces.

### BRIEF SUMMARY OF THE INVENTION

This invention uses both superhydrophilic and superhydrophobic powders to modify synthetic fibers in such a way as to make them extremely water attractive or repellant. Using both superhydrophilic (SHL) and superhydrophobic (SHB) powder, made with a special composition of sodium borosilicate “EX24” glass or diatomaceous earth, non-water-repellant fabrics were converted to water repellant superhydrophobic fabrics, and vice-versa, by electrostatic spray coating and chemical bonding. This was demonstrated on two types of non-woven fabrics and natural cotton fabrics using both superhydrophilic and superhydrophobic powder. The non-woven fabrics were composed of synthetic polymers.

The invention includes a superhydrophilic fabric having a superhydrophilic powder disposed on the fabric, wherein the superhydrophilic powder further comprises at least one material selected from the group consisting of sodium borosilicate glass and porous diatomaceous earth. The powder material has a contiguous interpenetrating structure with a plurality of spaced apart nanostructured surface features. The superhydrophilic powder can further have at least one superhydrophobic material selected from the group consisting of perfluorinated organics, fluorinated organics, and self-assembled monolayers, thereby switching the powder to a superhydrophobic powder for disposing on fabric.

### BRIEF DESCRIPTION OF THE DRAWINGS

FIG. 1 is a photograph of a superhydrophobic material of this invention.

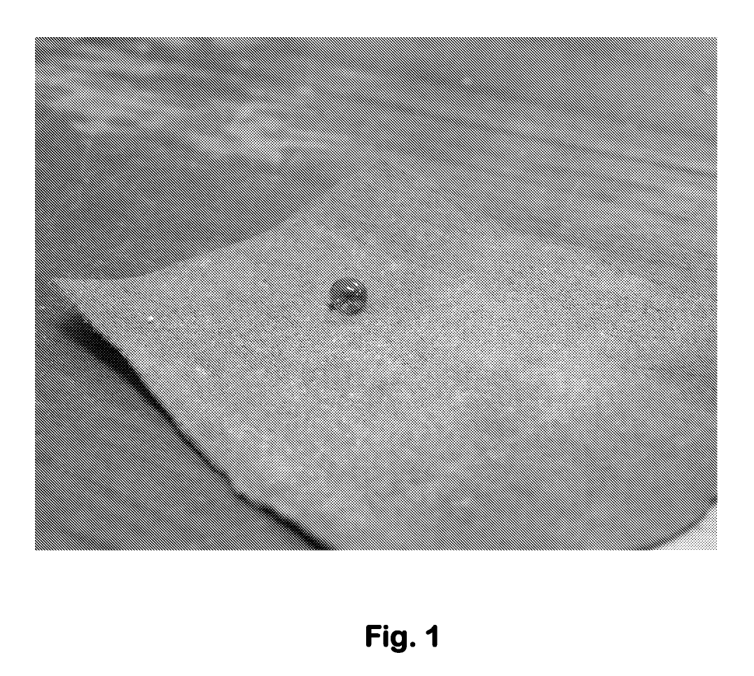

### DETAILED DESCRIPTION OF THE INVENTION

Both superhydrophilic (SHL) and superhydrophobic (SHB) powders, including powder made from specially formulated sodium borosilicate glass and powder made from diatomaceous earth, are applied to fabric for attracting and repelling water. Examples and further explanation of these powders is found in co-pending U.S. patent application Ser. No. 11/749,852, filed May 17, 2007, and U.S. patent application Ser. No. 11/777,486, entitled “Superhydrophobic Diatomaceous Earth”, filed Jul. 13, 2007, both herein incorporated by reference. The superhydrophilic and superhydrophobic powders converted non-water-repellant fabrics to water repellant superhydrophobic fabrics, and vice-versa, by electrostatic spray coating and chemical bonding the SHL and SHB powders to the fabric. This was demonstrated on two types of non-woven fabrics and an all cotton fabric using both superhydrophilic and superhydrophobic powder. The non-woven fabrics were composed of synthetic polymers.

The superhydrophilic glass powder is formed from an interpenetrating blend or composite of a plurality of materials where at least one material protrudes from the other materials at the surface of the particle after the removal of at least some of one or more materials. The glass powder has a plurality of pores that permit flow of a gas or a liquid through the powder. Each material is contiguous and the different materials form an interpenetrating structure. The particles that make up the glass powder are in the range of about 100 nanometers to about 10 microns in size and have protrusions that are small relative to the size of the particles such that a plurality of protrusions is present on a given particle. The SHB particles have at least one hydrophobic material included in the plurality of materials, including the protruding material, or the particle is coated with a hydrophobic material such that the surface retains the general topography of protrusions from the surface of the particles and the surface is hydrophobic. The particles have pores, and a portion of these pores have connectivity through the particle by the removal of some or all of at least one of the non-protruding (recessing) materials. The combination of a hydrophobic protruding material or hydrophobic coated surface with the topography of the particle results in superhydrophobicity of the particles. The superhydrophobic glass material is preferably a perfluorinated or fluorinated organic material. The coating can be a fluorinated self-assembly monolayer.

There are no limits to the variations of sizes and shapes of the nanostructured surface of the particles. The blend or composite used to form the particles may be made from any materials differentially etchable by any known etching method or combination of methods.

The respective interpenetrating contiguous materials used to form the particles are differentially etchable (i.e. have different etch rates), when subjected to one or more etchants and have an interconnected structure with two or more phases, such as that resulting from spinodal decomposition. The phase separation permits the generation of a protruding phase and a recessive phase by differentially etching the particles where one material phase is removed to a much greater degree than the other phase or phases. In the limit the entire more readily etched recessive phase may be removed entirely. Porosity results from the etching of the recessive phase to the extent that channels are formed within the particle, some of which may interconnect to form a continuous void generally, but not necessarily, with a tortuous path that extends from one side of the particle to another.

Superhydrophilic and superhydrophobic diatomaceous earth-derived powder can be prepared where porous diatomaceous earth (DE) particles having a surface that is a continuous hydrophobic layer which conforms to and is bound to the surface of the DE particles. Further explanation of the DE particles is found in co-pending U.S. patent application Ser. No. 11/777,486, entitled “Superhydrophobic Diatomaceous Earth”, filed Jul. 13, 2007, herein incorporated by reference. The superhydrophilic DE particles preferably have the surface structure of uncalcined DE. The hydrophobic layer is preferably a self assembled monolayer (SAM) such that the topography of the DE particle is retained. Preferred hydrophobic layers include perfluorohydrocarbon moieties, and a preferred perfluorohydrocarbon moiety includes a tridecafluorohexyl unit. Alternately the hydrophobic layer can include hexafluoropropene oxide oligomer moieties. It may be advantageous to mill or partially crush the DE in order to have smaller grains and thus increase the powder uniformity and total coverage. But, it is anticipated that over crushing the DE particles to the point that the resulting grain sizes are less than 1 micron may reduce or even eliminate its superhydrophobic behavior. This is the potential advantage with the spinodal glass powder in that it can be crushed to a much smaller size and will still retain its superhydrophobic behavior.

Both the SHL and SHB powder can be disposed on fabric using electrostatic spraying which places a negative charge on the powder particles. One example electrostatic gun charges the powder particles to 10,000 volts. When sprayed in the vicinity of a grounded metal plate, the particles accelerate toward the plate via electrostatic forces. Non-woven fabrics were placed between the charged powder and a grounded plate. The powder hit the polymer based fabrics with a high velocity causing the powder to be embedded into the polymer matrix (i.e. fabric surface). The result is a fabric surface with embedded both superhydrophilic and superhydrophobic powder making the fabric extremely water attractive or repellant.

An alternative to embedding the particles into the fabric surface is to add the particles during production of these fabrics. During the “sticky” stage of the process, the fabric surface can easily bond to other materials, especially porous materials like the superhydrophilic and superhydrophobic powders. The powder is electrostatic sprayed onto the fabric at that stage thereby making the particles integral with the fabric surface.

The SHL and SHB fabric can also be produced by any typical solid-on-solid process for the textile industry including xerographic printing of fabrics, liquid spray coloration, liquid spray finishing of fabrics, chemical binding of nonwoven fabrics, fluoropolymer finishing of nonwoven fabrics using electrostatic spraygun systems, and slashing of yarns using a fluidized bed system. Any textile process involving applying a chemical that produces a film on fiber surfaces (“interfiber finishes”) is a candidate. The electrostatic liquid spray approach uses oligomeric resins that require no solvent and thereby results in 100% solid deposition on the textile after film cure. This approach opens the possibility for both intrafiber finishing (e.g., permanent press resins) and solid shade coloration.

Another approach to binding both superhydrophilic and superhydrophobic powders to fabric is to chemically bond the powders to the given fabric via bonding agents that allow the powders to bind to the given substrate without destroying the powder's properties. There are many potential bonding agents which can be used. One powder binding method uses a solution consisting of either the superhydrophilic or superhydrophobic powder, a type of solvent (e.g. acetone) and small amounts of binder material (e.g. polystyrene or an acrylic resin based binder known as FastTrack XSR). The solution is “painted” on a fabric surface. When the solvent dries, the powder is bonded to the surface via the bonding agent.

Chemical or resin bonding is a generic term for interlocking fibers by the application of a chemical binder. The chemical binder most frequently used to consolidate fiber is water-borne latex. Most latex binders are made from vinyl materials, such as polyvinylacetate, polyvinylchloride, styrene/butadiene resin, butadiene, and polyacrylic, or their combinations. Latexes are extensively used as nonwoven binders, because they are economical, versatile, easily applied, and effective adhesives.

The chemical composition of the monomer or backbone bonding material determines stiffness/softness properties, strength, water affinity (hydrophilic/hydrophobic balance), elasticity, durability, and aging. The type and nature of functional side groups determines solvent resistance, adhesive characteristics, and cross-linking nature. The type and quantity of surfactant used influences the polymerization process, polymer stability, and the application method.

Chemical binders are applied to fabric in amounts ranging from about 1% to as much as about 60% by weight. In some instances, when clays or other weighty additives such as the diatomaceous earth powder are included, add-on levels can approach or even exceed the weight of the fabric web. Waterborne binders are applied by spray, saturation, print, and foam methods. A general objective of each method is to apply the binder material in a manner sufficient to interlock the fibers and provide SH fabric properties. The common methods of bonding include saturation, foam, spray, print and powder bonding.

According to the present invention, it has been discovered that both superhydrophilic and superhydrophobic powder can be applied to fabrics. Indeed, it is believed that both superhydrophilic and superhydrophobic coatings may be applied according to one or more methods of the present invention to a surface of essentially any article made from essentially any material. The degree of water attractiveness and repellent is controlled in the manufacturing process of the fabric. A controlled admixture of SHL and SHB particles can control the degree of water repellent behavior in the fabric.

The SHL and SHB powder compositions when deposited on a fabric forms a composite having increased water repellency or attractiveness compared to the fabric alone. Both superhydrophilic and superhydrophobic coating compositions and methods of the present invention may be selected singularly or in combination to produce a composite having a surface that is selectively superhydrophilic or superhydrophobic (e.g., a contact angle between the coating and water thereon of less than about 5° for SHL or at least about 150°, preferably at least about 160°, more preferably at least about 165°, and still more preferably at least about 170° for SHB). In addition to increasing the hydrophobicity or hydrophilicity of a fabric, a coating of the present invention may impart the property of self-cleaning.

While there has been shown and described what are at present considered the preferred embodiments of the invention, it will be obvious to those skilled in the art that various changes and modifications can be made therein without departing from the scope.

I claim:

1. A superhydrophilic fabric comprising;
a fabric,
a superhydrophilic powder disposed on said fabric,
wherein said superhydrophilic powder further comprises at least one material selected from the group consisting of sodium borosilicate glass and porous diatomaceous earth, and
wherein said material further comprises a contiguous interpenetrating structure with a plurality of spaced apart nanostructured surface features.

2. The fabric of claim 1 wherein said fabric is at least one selected from the group consisting of non-woven fabric, all cotton fabric, and non-woven synthetic polymer fabric.

3. The fabric of claim 1 wherein said superhydrophilic powder comprises particle sizes in the range of about 100 nanometers to about 10 microns.

4. The fabric of claim 1 wherein said diatomaceous earth is uncalcined.

5. The fabric of claim 1 wherein said superhydrophilic powder is produced from spinodal decomposition.

6. The fabric of claim 1 wherein said superhydrophilic powder is disposed on the fabric using at least one process selected from the group consisting of electrostatic spraying, solid-on-solid, and chemical bonding.

7. The fabric of claim 6 wherein said chemical bonding further comprises at least one binder selected from the group consisting of solvents, polystyrenes, acrylics, and water-borne latexes.

8. The fabric of claim 1 wherein said superhydrophilic powder further comprises at least one superhydrophobic material selected from the group consisting of perfluorinated organics, fluorinated organics, and self-assembled monolayers, thereby making superhydrophobic powder.

9. The fabric of claim 8 wherein said self-assembled monolayers further comprise at least one material selected from the group consisting of a perfluorohydrocarbon, a hexafluoropropene oxide oligomer, and a tridecafluorohexyl.

10. The fabric of claim 8 wherein said fabric is at least one selected from the group consisting of non-woven fabric, all cotton fabric, and non-woven synthetic polymer fabric.

11. The fabric of claim 8 wherein said superhydrophobic powder comprises particle sizes in the range of about 100 nanometers to about 10 microns.

12. The fabric of claim 8 wherein said diatomaceous earth is uncalcined.

13. The fabric of claim 8 wherein said superhydrophobic powder is produced from spinodal decomposition.

14. The fabric of claim 8 wherein said superhydrophobic powder is disposed on the fabric using at least one process selected from the group consisting of electrostatic spraying, solid-on-solid, and chemical bonding.

15. The fabric of claim 14 wherein said chemical bonding further comprises at least one binder selected from the group consisting of solvents, polystyrenes, acrylics, and water-borne latexes.
